(19) United States
(12) Patent Application Publication
(10) Pub. No.: US 2019/0248488 A1
(43) Pub. Date: Aug. 15, 2019

(54) System and Method for Persistent Airborne Surveillance Using Unmanned Aerial Vehicles (UAVs)

(71) Applicant: The United States of America, as represented by the Secretary of the Navy, Arlington, VA (US)

(72) Inventors: Oleg A. YAKIMENKO, Seaside, CA (US); Alexander G. WILLIAMS, Monterey, CA (US)

(21) Appl. No.: 16/273,278

(22) Filed: Feb. 12, 2019

Related U.S. Application Data
(60) Provisional application No. 62/629,217, filed on Feb. 12, 2018.

(51) Int. Cl. B64C 39/02; G06K 9/00

(52) U.S. Cl. CPC B64C 39/024; G06K 9/00771; B64C 2201/042; B64C 2201/141; B64C 2201/127

(57) ABSTRACT

Using battery monitoring and unmanned aerial vehicle (UAV) management, a method and system provide persistent airborne surveillance for intelligence, surveillance, and reconnaissance (ISR) systems supported by UAVs within an airborne surveillance pattern (ASP). In one embodiment, a UAV operating in the ASP with degraded battery charge is autonomously swapped with a UAV having a fully-charged battery to provide persistent aerial surveillance for an extended duration over that of a single UAV.

### CROSS-REFERENCE TO RELATED APPLICATIONS

This application claims the benefit of U.S. Provisional Application No. 62/629,217, filed Feb. 12, 2018, which is hereby incorporated in its entirety by reference.

### BACKGROUND OF THE INVENTION

### 1. Field of the Invention

The present invention relates generally to battery management of unmanned aerial vehicles (UAVs) used in airborne missions to allow persistent airborne coverage within an airborne surveillance pattern (ASP) using multiple UAVs.

### 2. Description of the Related Art

Unmanned systems are currently at the forefront of research and development for many industries, including commercial industries, homeland security, and the military. Commercial development and use of unmanned systems for filming movies, delivering packages, conducting engineering evaluations on difficult-to-reach equipment, and for use in hobbyist racing are just some of the applications driving companies to spend billions in advancing the technologies. Military units utilize unmanned systems for intelligence, surveillance, and reconnaissance (ISR) collection. Unmanned systems operate with increasingly more advanced autonomy. A key aspect of enhancing autonomy is providing persistency, however, on-board fuel and battery capacity, for electrically powered systems in particular, limit the operational time of many systems characterized as persistent. Many of the systems currently in use have limited flight times due to battery limitations. Typically, these systems use rechargeable lithium polymer (LiPo) batteries providing a higher specific energy than other battery types, but still having a very limited flight endurance of about 20-30 minutes.

### SUMMARY OF THE INVENTION

Embodiments in accordance with the invention, provide a persistent airborne operating platform for user-specified ISR systems covering an area or perimeter for an extended duration utilizing multiple UAVs, rather than a single UAV; UAVs are swapped in an ASP autonomously based on a method which provides UAV battery charge level monitoring and UAV management via a control station.

In accordance with one embodiment, a system for persistent airborne surveillance includes: a plurality of unmanned aerial vehicles (UAVs), each of the UAVs including a battery for powering the UAV, a battery charge level monitor, a flight control module, one or more intelligence, surveillance, and reconnaissance (ISR) systems, the one or more ISR systems for providing an associated airborne surveillance from an airborne surveillance pattern (ASP), and, a communication module for sending and receiving communications; a battery recharge/replacement station with a limited stock of fully-charged batteries; and, a computer-based control station for sending information to and receiving information from at least each of the UAVs, the control station including at least a method for persistent airborne surveillance, the method managing the exchange of a first UAV in the ASP with a next UAV based on the battery charge level of the first UAV, such that at least one UAV in the plurality of UAVs is actively operating in the ASP to provide persistent airborne surveillance by the one or more ISR systems, a processor for executing the operations of the method, and, one or more interfaces for communicating information from the control station to the plurality of UAVs.

In accordance with another embodiment, a method for persistent airborne surveillance includes: a) sending an unmanned aerial vehicle (UAV) to an airborne surveillance pattern (ASP), the UAV having one or more intelligence, surveillance, and reconnaissance (ISR) systems for providing an associated airborne surveillance from the ASP, the UAV becoming defined as an operating UAV while in the ASP; b) receiving a battery charge level of the operating UAV; c) determining whether the battery charge level is greater than a specified battery charge level threshold; d) wherein when the battery charge level is greater than the battery charge level threshold, returning to operation b); and, e) wherein when the battery charge level of the UAV is not greater than the battery charge level threshold, sending a next UAV to enter the ASP, the next UAV having one or more ISR systems for providing an associated airborne surveillance from the ASP, replacing the operating UAV with the next UAV in the ASP such that airborne surveillance by the one or more ISR systems is not interrupted, sending the operating UAV out of the ASP to a battery recharge/replacement location for battery recharge or replacement such that the operating UAV is no longer defined as an operating UAV, and the next UAV becomes defined as the operating UAV in the ASP; and returning to operation b).

Embodiments in accordance with the invention are best understood by reference to the following detailed description when read in conjunction with the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. Herein the figures are not drawn to scale, but are set forth to illustrate various embodiments of the invention.

FIG. 1 is an illustration of a persistent airborne surveillance system in accordance with one embodiment of the invention.

FIG. 2, shown as partial views FIG. 2A and FIG. 2B, illustrates a process flow diagram of a persistent airborne surveillance method utilizing three UAVs in accordance with one embodiment of the invention.

FIGS. 3A-3K illustrate the method of FIG. 2 in which three UAVs are utilized to provide persistent airborne surveillance in accordance with one embodiment of the invention.

FIG. 4 illustrates a multirotor UAV swapping schedule with nine batteries utilizing a three-UAV configuration in accordance with one embodiment of the invention.

FIG. 5 illustrates a multirotor UAV swapping schedule with nine batteries utilizing a four-UAV configuration in accordance with one embodiment of the invention.

FIG. 6 illustrates a system network architecture of a prototype system for persistent airborne surveillance using UAVs in accordance with one embodiment of the invention.

FIG. 7 illustrates drone specifications for the UAVs used in the prototype system of FIG. 6.

FIG. 8 illustrates port identifiers for the UAVs used in the prototype system of FIG. 6 in accordance with one embodiment of the invention.

FIG. 9 illustrates system mobility MOE and MOPs of the prototype system of FIG. 6 in accordance with one embodiment of the invention.

FIG. 10A illustrates altitude profiles for a three UAV/five battery prototype system configuration in accordance with one embodiment of the invention.

FIG. 10B illustrates the battery life profiles for a three UAV/five battery prototype system configuration in accordance with one embodiment of the invention.

FIG. 11 illustrates a loiter time comparison for a five-battery experiment in accordance with one embodiment of the invention.

FIG. 12 illustrates the overall flight time for each UAV flown in the prototype system of FIG. 8 in accordance with one embodiment of the invention.

FIG. 13A illustrates the altitude profiles for a three UAV/nine battery prototype system configuration in accordance with one embodiment of the invention.

FIG. 13B illustrates the battery life profiles for a three UAV /nine battery prototype system configuration in accordance with one embodiment of the invention.

FIG. 14 illustrates a loiter time comparison for a full-scale nine-battery prototype system in accordance with one embodiment of the invention.

Embodiments in accordance with the invention are further described herein with reference to the drawings.

### DETAILED DESCRIPTION OF THE INVENTION

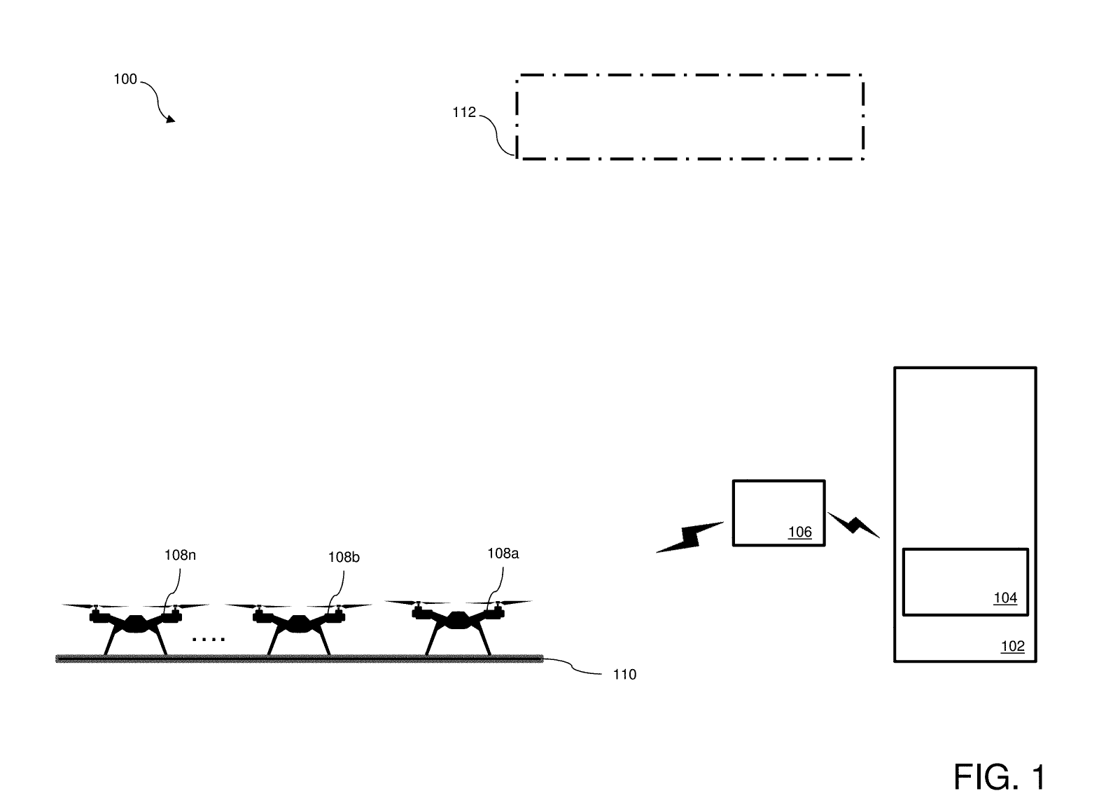

FIG. 1 is an illustration of a persistent airborne surveillance system 100 in accordance with one embodiment of the invention. Referring now to FIG. 1, in one embodiment, system 100 includes one or more UAVs 108, illustrated individually in FIG. 1 as UAVs 108a, 108b, through 108n. In one embodiment, each of UAVs 108 includes a flight control module for enabling communications with UAV 108 and for enabling controlled flight and positioning of UAV 108, a battery for powering UAV 108, a battery charge level monitor for monitoring the battery charge level of the battery and for providing a battery charge level for transmission from UAV 108, and one or more ISR systems, as determined by a user. Herein ISR systems can include communications systems, monitoring systems, information gathering systems, or other systems supported by UAV 108. In one embodiment, when UAV 108 is positioned in an ASP 112, the ISR systems supported on UAV 108 can provide surveillance, to include operational coverage, over a selected area or perimeter. Herein ASP 112 is an aerial pattern in which one or more UAVs 108 can be positioned to support the operational surveillance of the one or more ISR systems supported on UAVs 108. In the current embodiment, each UAV 108, e.g., UAVs 108a, 108b, through 108n, is communicatively connected to a control station (CS) 102, such as a ground control station (GCS), which includes a persistent airborne surveillance method 104. In one embodiment, CS 102 is a computer-based system having a processing unit for executing software code and instructions which implement the operations of method 104, one or more memories, such as for storing method 104, and one or more interfaces for communicating with external systems, such as a router 106, a positioning module, such as a GPS module, and/or the Internet. CS 102 can also include a user input terminal, such as a keyboard, a display terminal, and data ports to connect external devices.

In one embodiment, method 104 receives the battery charge level of each UAV 108. Method 104 automatically directs a UAV 108 to ASP 112 or to a battery recharge/replacement location (BRL) 110 based on the battery charge level of a UAV 108 operating in ASP 112 in order to provide persistent airborne surveillance from ASP 112 to the surveillance systems supported by each UAV 108. In one embodiment, BRL 110 provides battery charging of a battery powering a UAV 108, or allows battery replacement of the battery powering a UAV 108. In the present embodiment, BRL 110 also serves as the launch platform for UAVs 108, however, in other embodiments, BRL 110 may be separate from a launch platform.

As further detailed herein, in one embodiment, method 104 receives a battery charge level transmission from a battery charge level monitor for a battery of a UAV 108 operating in ASP 112, such as a first UAV 108. When method 104 determines the battery charge level falls below a specified battery threshold level, method 104 automatically replaces first UAV 108 having a degraded battery charge level with a next UAV 108 having a battery charge level above the specified battery threshold level. First UAV 108 then returns to BRL 110, where the battery of first UAV 108 is recharged or replaced allowing first UAV 108 to later be returned to operation in ASP 112 as needed. In this way, continuity of operation for the surveillance systems supported by UAVs 108 within ASP 112 is extended by the continued exchange of UAVs 108 based on battery management of UAVs 108 in accordance with operations of method 104.

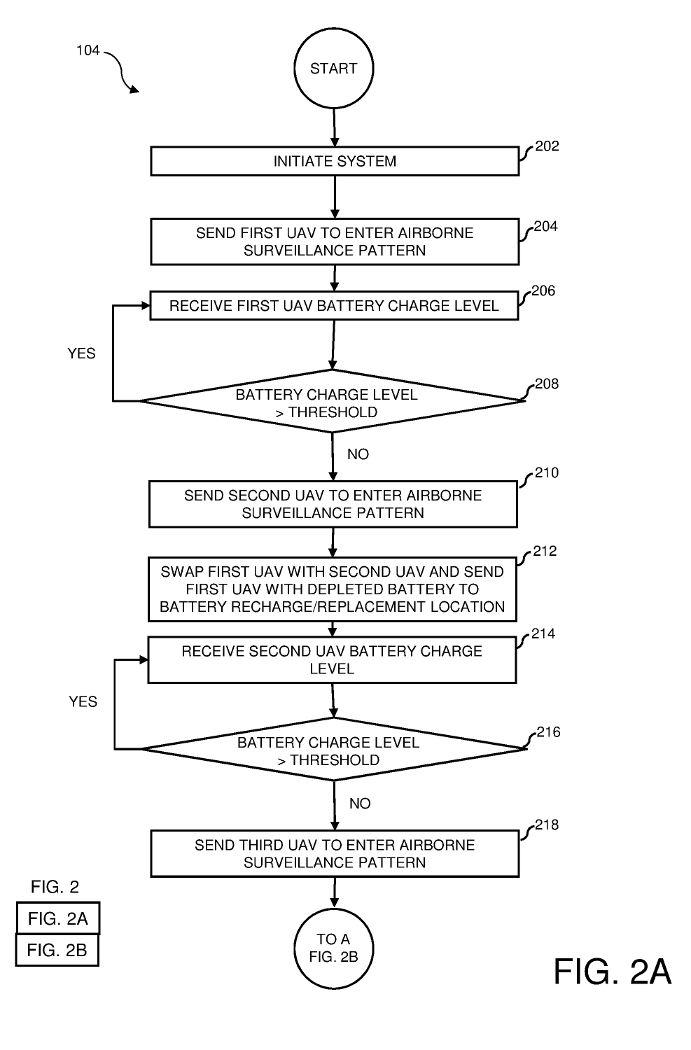

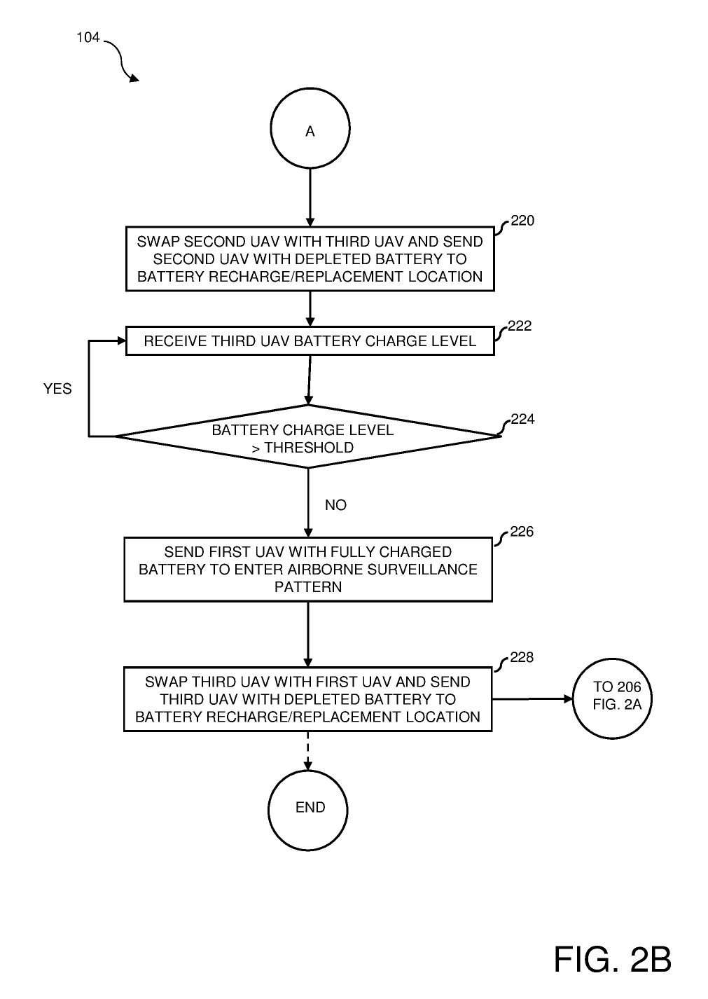

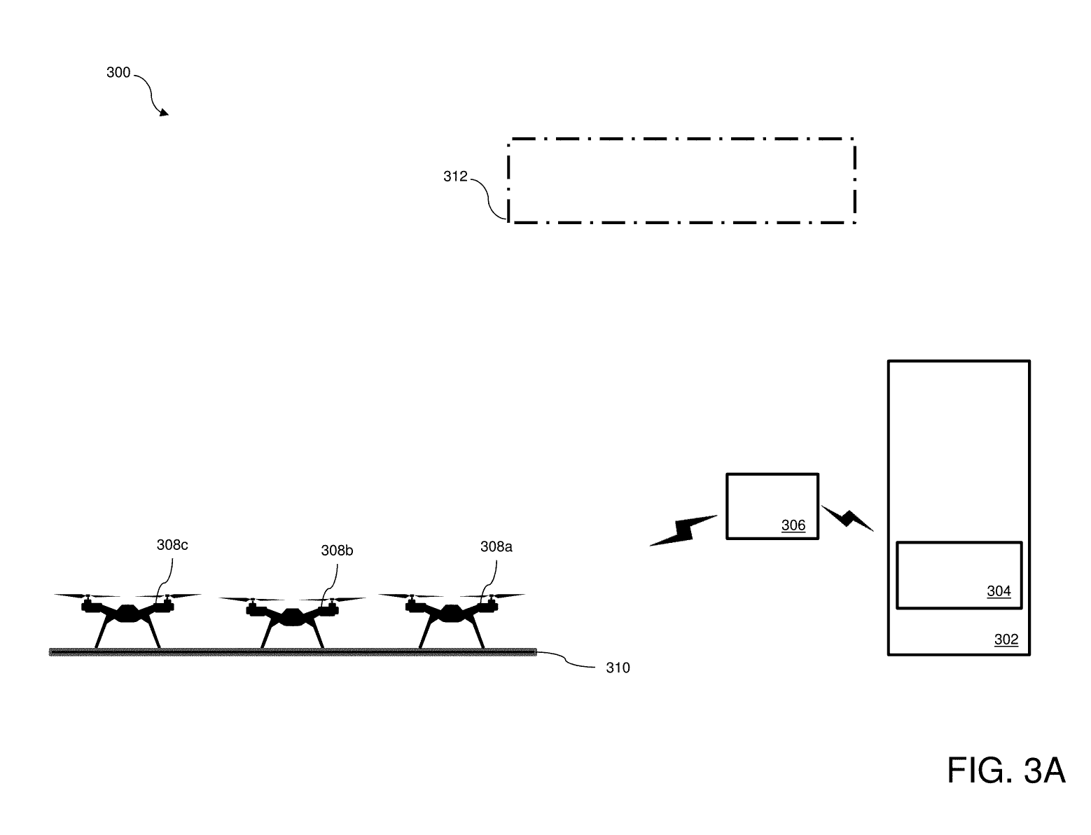

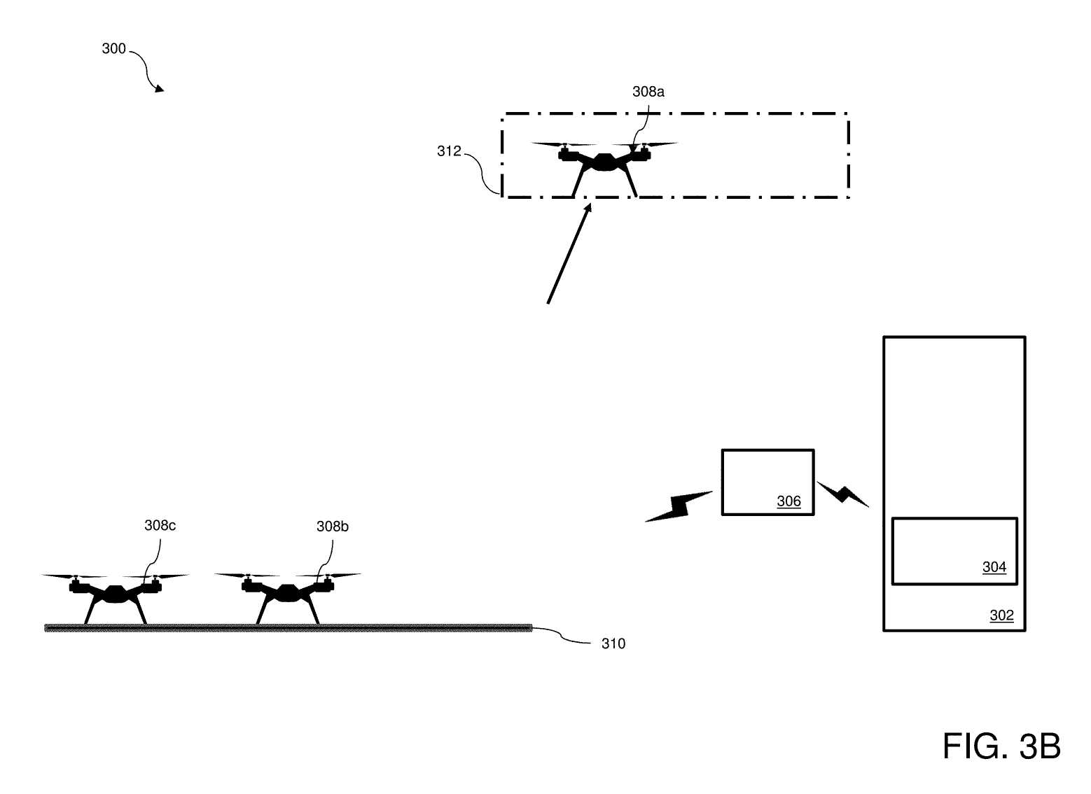

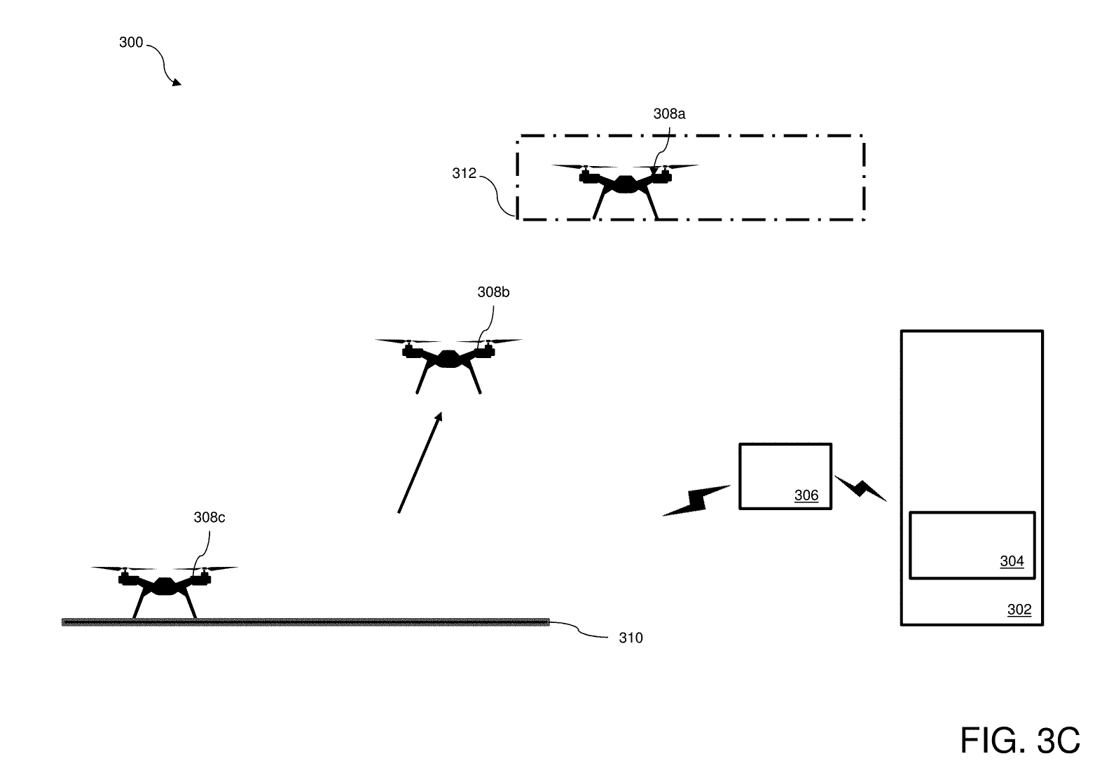

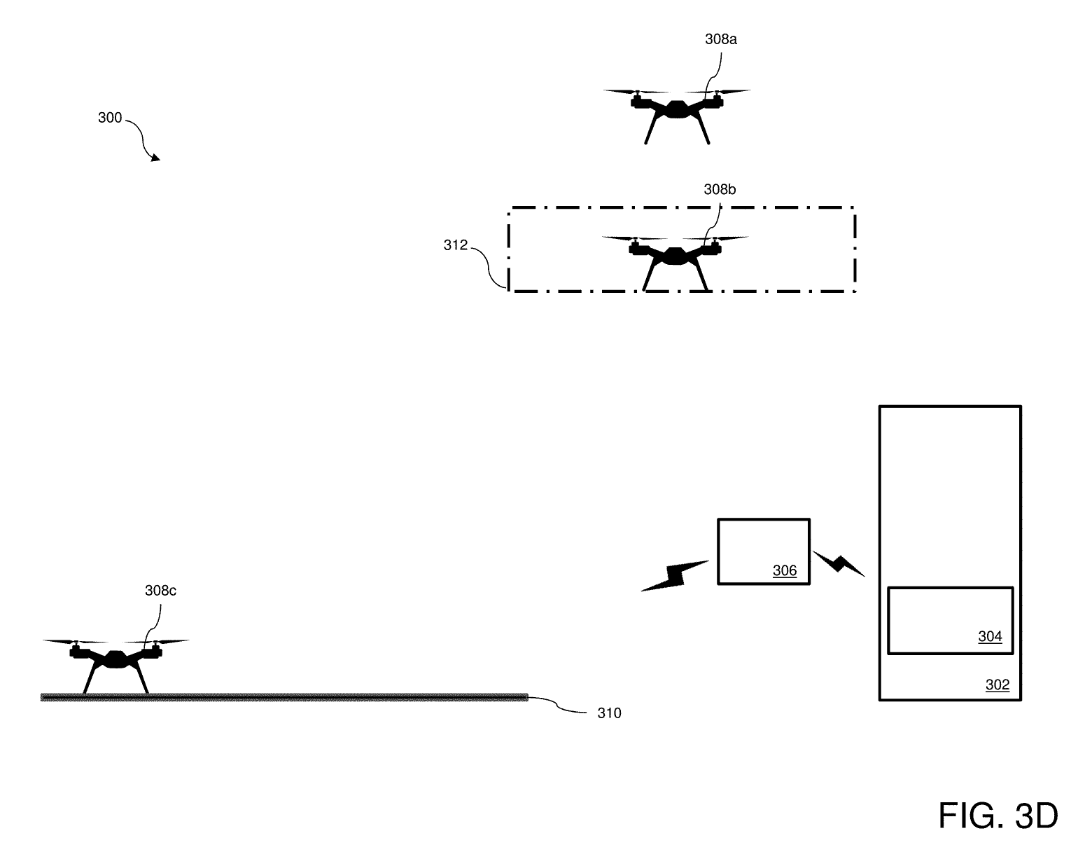

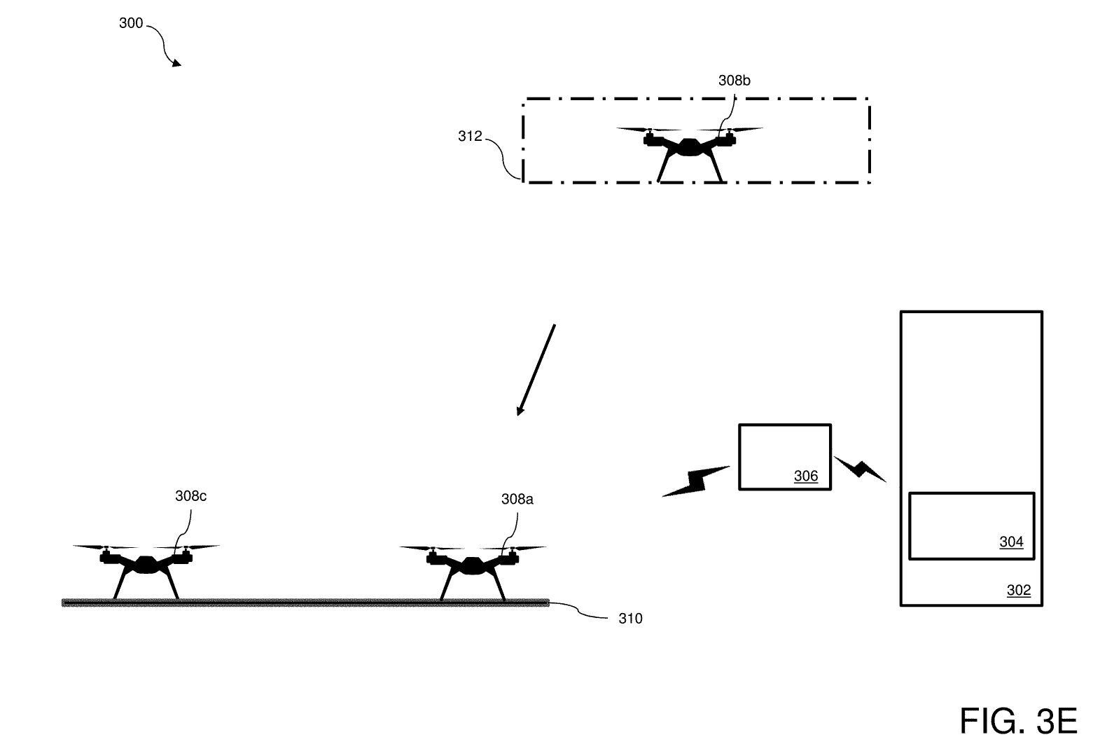

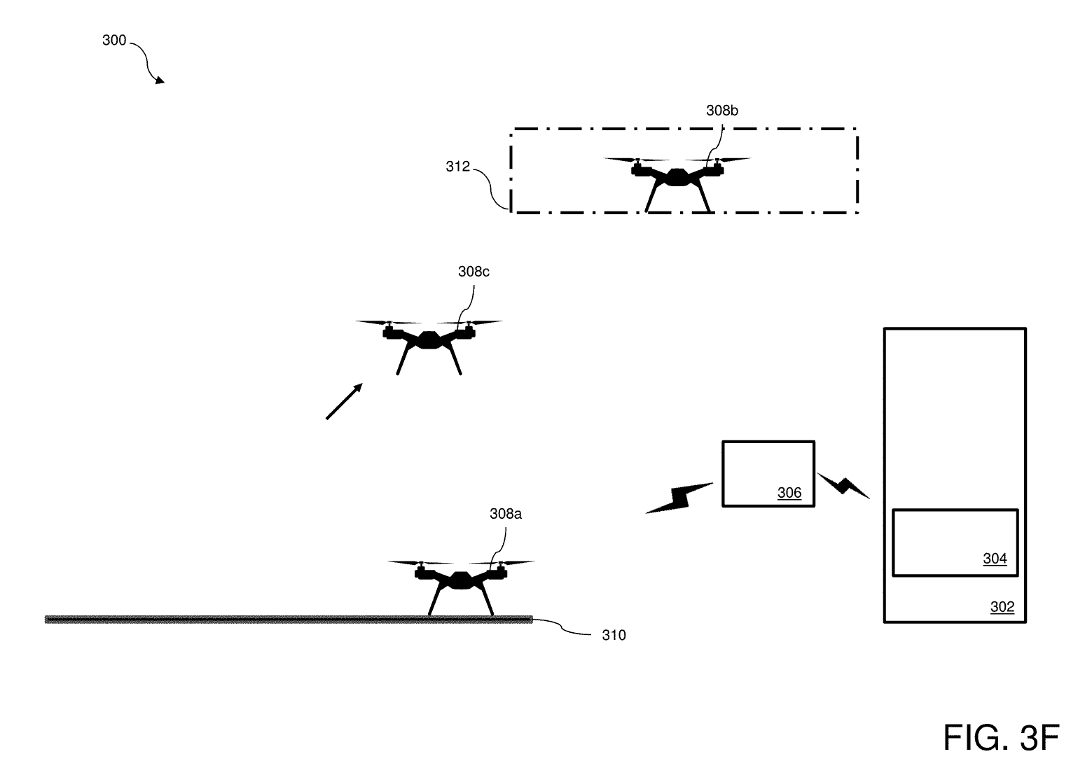

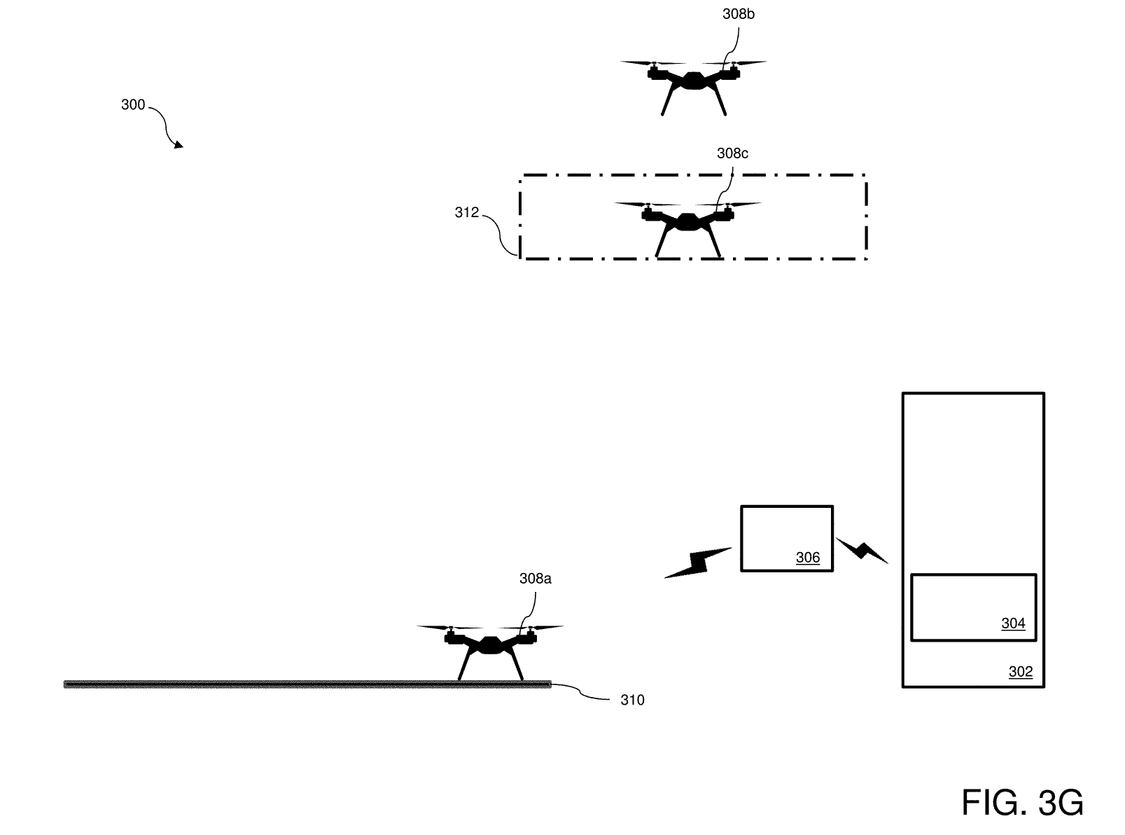

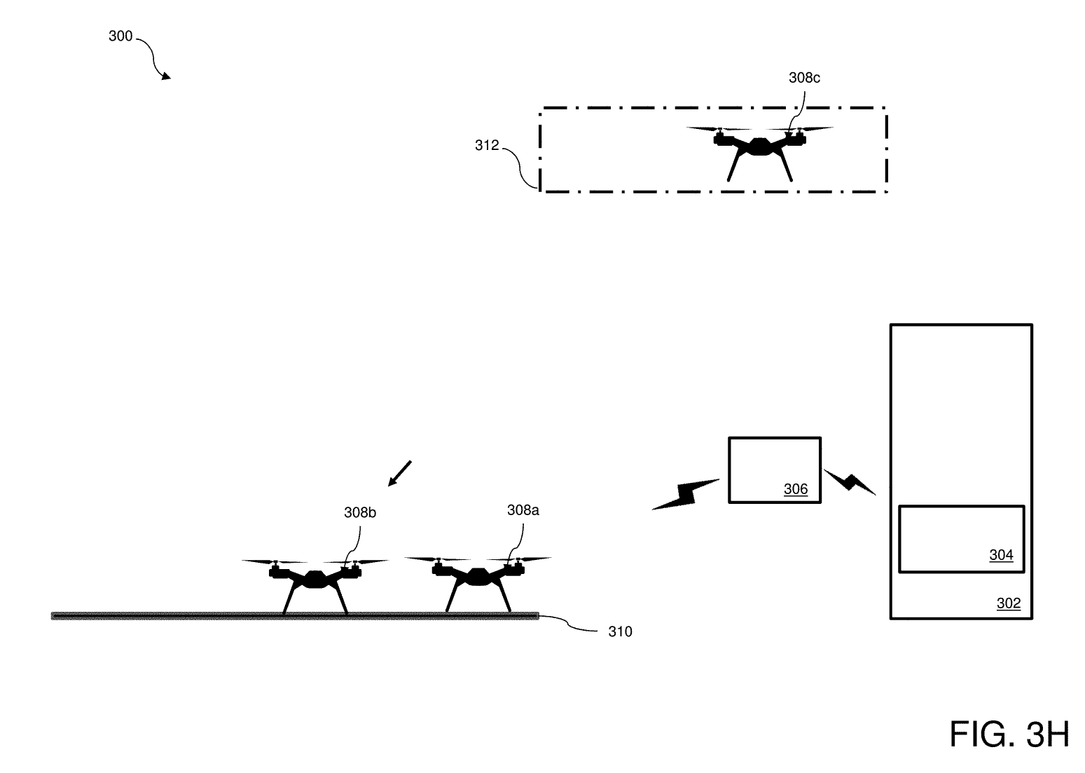

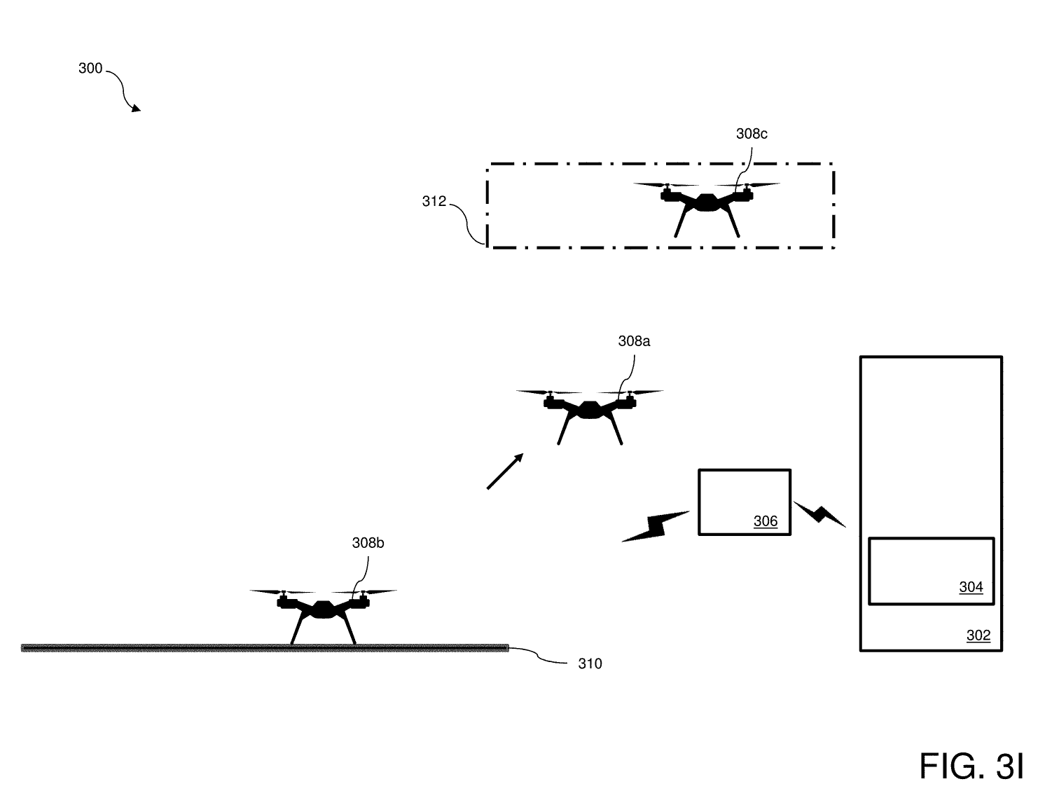

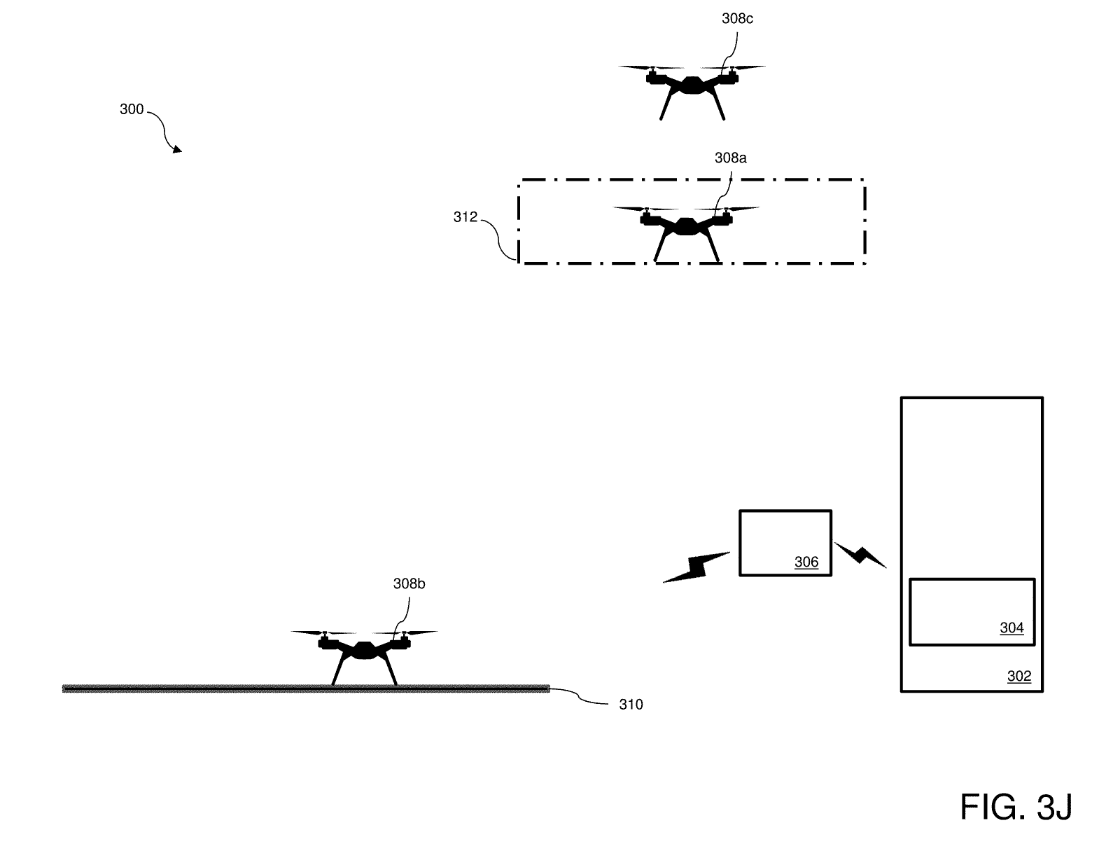

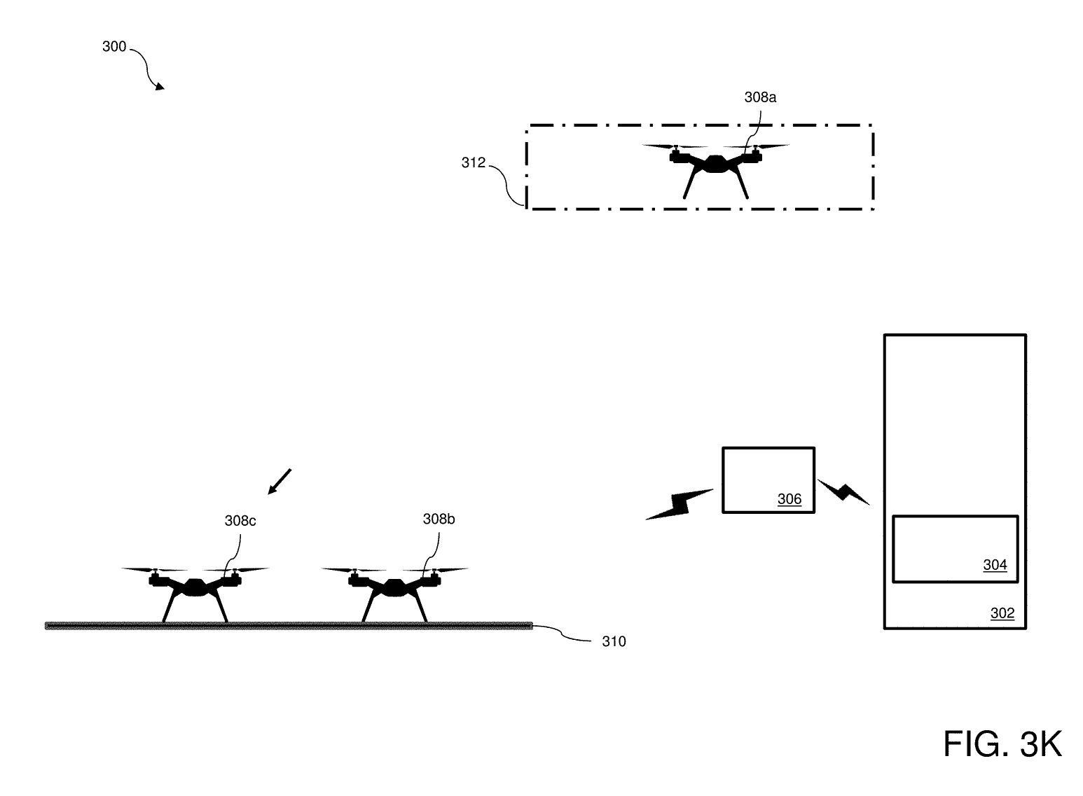

FIG. 2 illustrates a process flow diagram of method 104 for persistent airborne surveillance utilizing three UAVs in accordance with one embodiment of the invention. FIGS. 3A-3K illustrate the operation of method 104 in persistent airborne surveillance system 100, herein identified as persistent airborne surveillance system 300 in this embodiment, utilizing three UAVs 308 to provided persistent airborne surveillance from an ASP 312 in accordance with one embodiment of the invention.

Referring now to FIG. 2 and FIG. 3A together, in operation 202, method 104 is initiated. For example, communications between CS 302 and UAVs 308a, 308b, 308c are established via router 306 and initial battery charge level transmissions are sent to CS 302 and received by method 104. In some embodiments, method 104 performs a battery charge level check of all UAVs 308 programmed for operational use. In the present embodiment, UAVs 308 are launched from and return to BRL 310. Following operation 202, processing continues to operation 204.

In operation 204, instruction(s) are transmitted, via CS 302 and router 306, to a first UAV 308a to launch and proceed to a specified ASP 312, as shown in FIG. 3B. First UAV 308a aerially loiters and operates in ASP 312 providing airborne surveillance from ASP 312 for the ISR systems first UAV 308a is supporting.

In operation 206, while in ASP 312, a battery charge level monitor located in UAV 308a monitors a battery charge level of a battery powering UAV 308a and periodically communicates the battery charge level to CS 302 which is received by method 104.

In operation 208, a determination is made whether the received battery charge level of UAV 308a is greater than a specified battery charge threshold level. In one embodiment, the battery charge level threshold is greater than a battery charge level required to power a UAV 308 from ASP 312 to BRL 310.

When the received battery charge level is greater than the battery charge threshold level (“YES”), operation 208 returns to operation 206 and awaits a next battery charge level transmission from UAV 308a. Alternatively, when the received battery charge level is not greater than the battery charge threshold level (“NO”), operation 208 continues to operation 210, and method 104 automatically initiates operations to replace UAV 308a in ASP 312 with a second UAV 308b as further described.

In operation 210, method 104 automatically transmits instruction (s) to a second UAV 308b to launch and proceed to ASP 312 as shown in FIG. 3C. In one embodiment, the entry point into ASP 312 is predicted based on the operating UAV pace/pattern and time for the swapping UAV to reach it.

In operation 212, method 104 automatically transmits instructions(s) to first UAV 308a to return to BRL 310. In one embodiment, when second UAV 308b approaches ASP 312, first UAV 308a automatically vertically rises in the air to avoid collision with UAV 308b while continuing to serve as the operational airborne platform for the ISR systems it is supporting as shown in FIG. 3D. UAV 308b flies to ASP 312 previously occupied by UAV 308a. Once UAV 308b reaches ASP 312, UAV 308a returns to BRL 310 for a battery replacement or battery charging in order to be available for future use, as shown in FIG. 3E.

In operation 214, while in ASP 312, a battery charge level monitor located in UAV 308b monitors a battery charge level of a battery powering UAV 308b and periodically communicates the battery charge level to CS 302 and method 104.

In operation 216, a determination is made whether the received battery charge level of UAV 308b is greater than the specified battery charge threshold level. When the received battery charge level is greater than the battery charge threshold level (“YES”), operation 216 returns to operation 214 and awaits a next battery charge level transmission from UAV 308b. Alternatively, when the received battery charge level is not greater than the battery charge threshold level (“NO”), operation 216 continues to operation 218, and method 104 automatically initiates operations to replace UAV 308b in ASP 312 with a third UAV 308c as further described.

In operation 218, method 104 automatically transmits instruction (s) to a third UAV 308c to launch and proceed to ASP 312 as shown in FIG. 3F.

In operation 220, method 104 automatically transmits instructions(s) to second UAV 308b to return to BRL 310. In one embodiment, when third UAV 308c approaches ASP 312, second UAV 308b automatically vertically rises in the air to avoid collision with UAV 308c while continuing to serve as the operational airborne platform for the ISR systems it is supporting as shown in FIG. 3G. UAV 308c flies to ASP 312 previously occupied by UAV 308b. Once UAV 308c reaches ASP 312, UAV 308b returns to BRL 310 for a battery replacement or battery charging in order to be available for future use, as shown in FIG. 3H.

In operation 222, while in ASP 312, a battery charge level monitor located in UAV 308c monitors a battery charge level of a battery powering UAV 308c and periodically communicates the battery charge level to CS 302 and method 104.

In operation 224, a determination is made whether the received battery charge level of UAV 308c is greater than the specified battery charge threshold level. When the received battery charge level is greater than the battery charge threshold level (“YES”), operation 224 returns to operation 222 an awaits a next battery power level transmission from UAV 308c with continued operation of UAV 308c within ASP 312. Alternatively when the received battery charge level is not greater than the battery charge threshold level (“YES”), operation 224 continues to operation 226, and method 104 automatically initiates operations to replace UAV 308c in ASP 312 with first UAV 308a.

In operation 226, method 104 automatically transmits instruction (s) to first UAV 308a to launch and proceed to ASP 312 as shown in FIG. 3I. In the present embodiment, while first UAV 308a was at BRL 310, the battery of first UAV 308a was fully charged, e.g., at or near a 100% battery charge level.

In operation 228, method 104 automatically transmits instructions(s) to third UAV 308c to return to BRL 310. In one embodiment, when first UAV 308a approaches ASP 312, third UAV 308c automatically vertically rises in the air to avoid collision with UAV 308a while continuing to serve as the operational airborne platform for the ISR systems it is supporting as shown in FIG. 3J. UAV 308a flies to ASP 312 previously occupied by UAV 308c. Once UAV 308a reaches ASP 312, UAV 308c returns to BRL 310 for a battery replacement or battery charging in order to be available for future use, as shown in FIG. 3K.

From operation 228, processing returns to operation 206 (FIG. 2A), or alternatively ends when all batteries are exhausted, such that system 300 and method 104 can no longer use any of UAVs 308a, 308b, 308c, or when a user ends the mission, i.e., ends method 104.

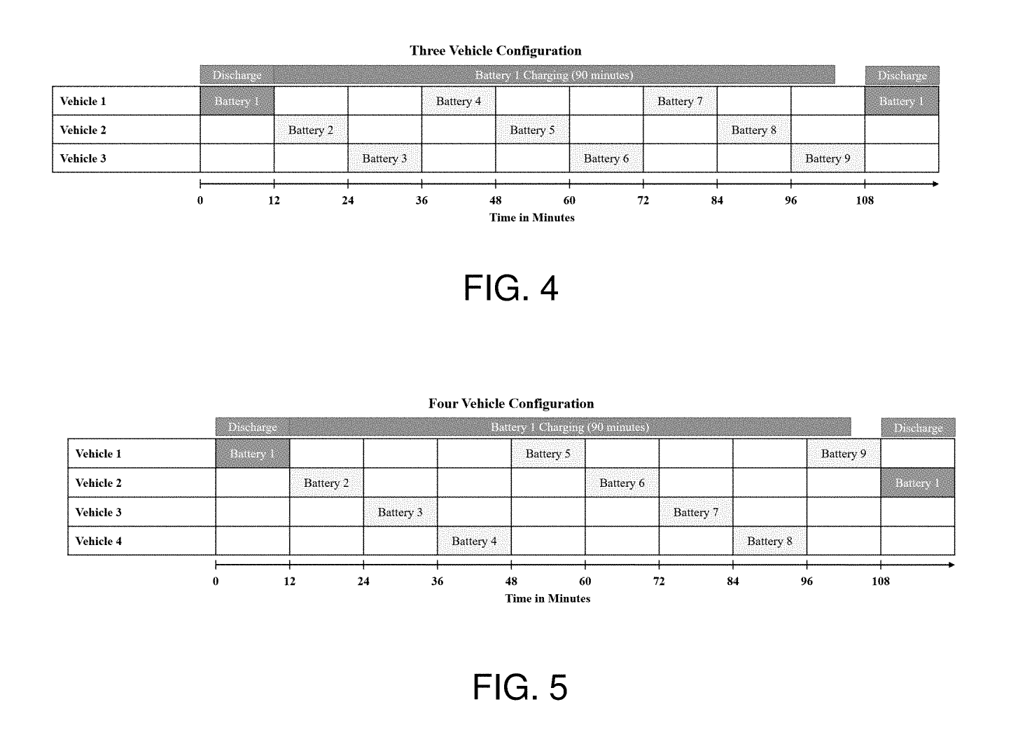

FIG. 4 illustrates a nine battery stock usage schedule utilizing a three UAV configuration composed of multirotor drones in accordance with one embodiment of the invention. FIG. 5 illustrates a nine battery stock usage utilizing a four UAV configuration composed of multirotor drones in accordance with one embodiment of the invention. Both configurations ensure indefinite operation time. In FIG. 4 and FIG. 5, it is assumed that an expected battery discharge time, T_{D}, is an average battery discharge time of twelve minutes, and that a time required to fully charge a battery, herein termed a battery charge time, T_{C}, is ninety minutes. Both FIG. 4 and FIG. 5 illustrate a time required to discharge a Battery 1, shown in orange, and a time required to fully charge Battery 1, shown in green.

The required number of batteries, N, to support a persistent operation is defined as

$$N = ceil ( 1 + \frac{{T}_{C}}{{T}_{D }} ) \qquad ( 1 )$$

In this particular example,

$$N = ceil ( 1 + \frac{90 min}{12 min} ) = ceil ( 8.5 ) = 9 \qquad ( 2 )$$

As can be understood by those of skill in the art, this number does not depend on the number of vehicles the system is composed of, but with more vehicles, the system becomes more robust—in case one vehicle becomes inoperable. A system which includes at least three individual UAVs, provides redundancy; however, given a particular operating area, where threats external to battery longevity may remove a UAV from operation, adding one or two additional UAVs to the system would make the system even more robust. It is arguable, that while systems using these configurations cannot be destroyed by the loss of a single UAV, removing one UAV from flight requires time to conduct UAV replacement. Thus, there would be a lapse in coverage by the supported ISR systems as the next available UAV is launched and moves into position.

Further described herein is an example of an embodiment of a prototype of system 100 consisting of three commercial off the shelf (COTS) UAVs. The hardware and software of the developed prototype system were used for a proof-of-concept field test. The hardware consists of the UAVs themselves and a wireless network, each of which, when properly configured, communicates with a laptop computer serving as a single ground control system (GCS).

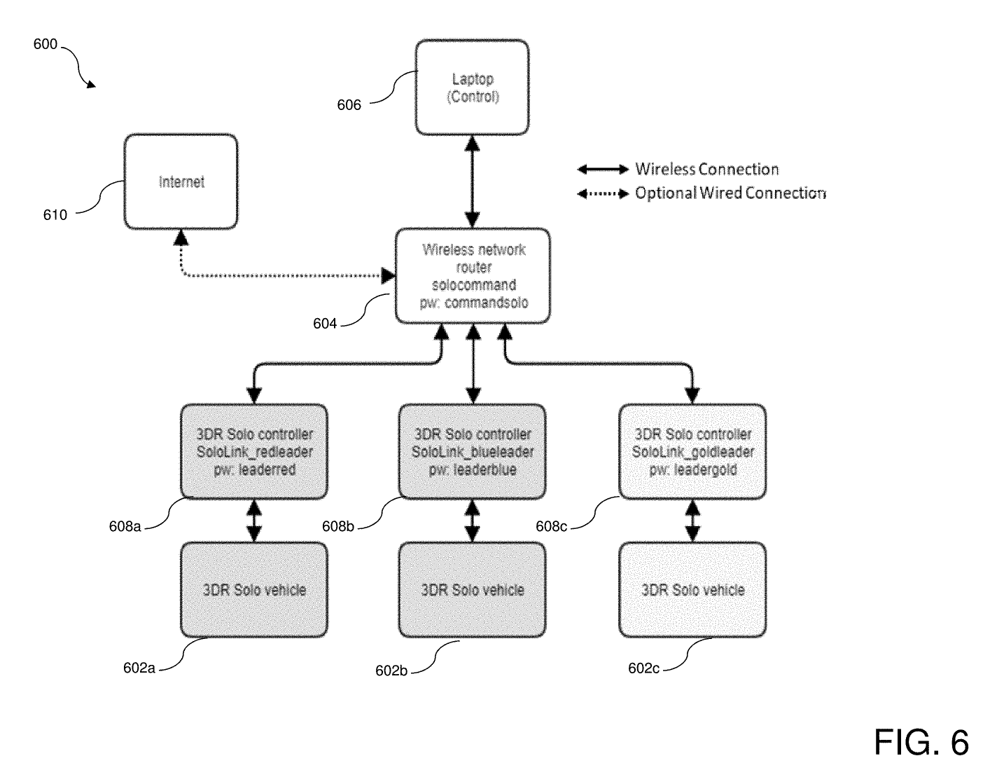

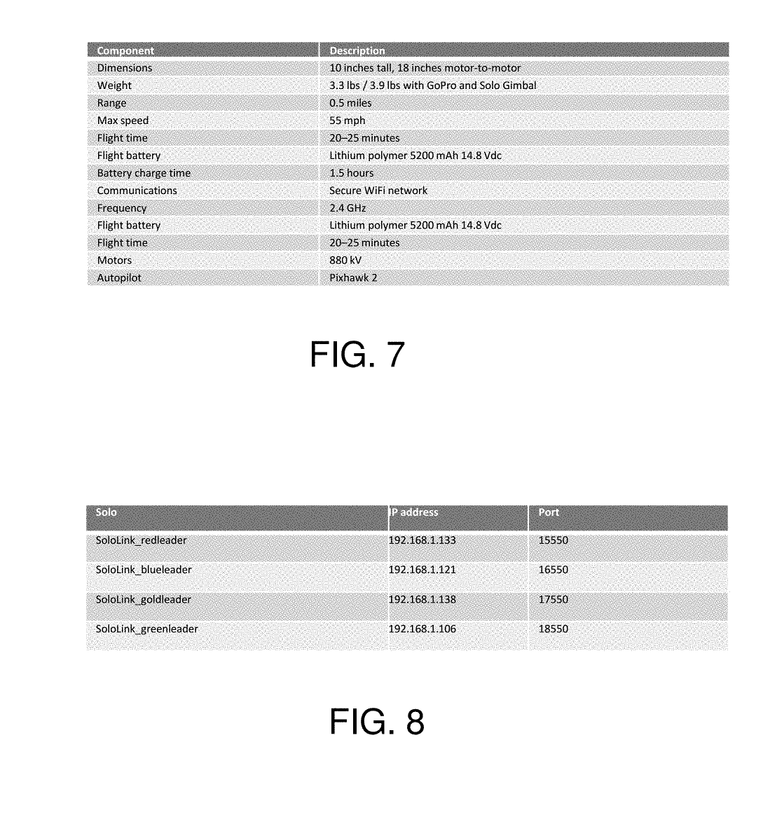

FIG. 6 illustrates a diagram of a developed network architecture of a prototype system 600 in accordance with one embodiment of the invention. For the purposes of field testing, the equipment included three UAVs that were 3DR Solo drones 602 (available from 3D Robotics, Inc., Berkeley, Calif.), shown individually in FIG. 6 as UAVs 602a, 602b, 602c, one wireless router 604 operating at 2.4 GHz, and a laptop computer 606 capable of running a computer programming language, such as the Python programming language (available from the Python Software Foundation at www.python.org). The specifications for UAVs 602 are shown in FIG. 7. UAVs 602a, 602b, 602c, are connected to laptop GCS 606 through wireless network router 604. The network shows solid lines to indicate wireless connections, and a dotted line to show an optional connection. The three colored blocks represent individual UAV controllers 608, shown individually in FIG. 6 as controllers 608a, 608b, 608c, with the UAVs 602a, 602b, 602c, respectively. The network diagram of FIG. 6 illustrates the critical path and dependencies for connectivity.

In the present embodiment, system 600 operated the three UAVs 602 autonomously from the single ground control station, i.e., the laptop computer 606. To monitor the vehicle battery charge level and swap UAVs 602, when necessary, system 600 operated on a common network. UAVs 602 and laptop computer 606 were connected through a single wireless access point operating at 2.4 GHz, router 604. The wireless access point, router 604, allowed the ability to access both an Internet 610 and any of the UAVs 602 on the network. The Internet access allows updating the UAVs 602 firmware but otherwise was not really necessary for the purpose of the prototype system development or testing. The developed prototype system 600 is capable of operating with additional UAVs 602, as long as the UAVs are configured properly and their associated Internet protocols and ports are written into the software code used to control prototype system 600.

From the manufacturer, each UAV 602 comes set up to connect with its included controller 608. Using the network protocol Secure Socket Shell (SSH), each UAV 602 and controller 608 is remotely reconfigured. To operate the system properly, port identifiers for each UAV 602 should be assigned along with the network Service Set Identifier (SSID) information necessary to connect to a single wireless network. Since UAVs 602 communicate with the ground control station, laptop computer 606, via User Datagram Protocol (UDP) broadcast ports, the default ports used by each UAV 602 are changed to make sure they do not interfere with each other. FIG. 8 shows the port identifiers used in the testing. The default UAV port (14550) was left open to prevent another UAV with the default setting flying nearby accidentally interfering, e.g., connecting with, the prototype system network.

In one embodiment, the software Python programming language was the primary means of developing autonomous system function. Using the documentation—provided as part of DroneKit-Python—an online software development kit, and multiple smaller field tests UAVs 602 were configured to conduct flight operations initiated by the Python script. The code for the system followed a six-step development cycle: collecting battery data, verifying multiple vehicle connectivity, launching vehicles on command, vehicle flight control, vehicle swapping, and data logging.

Initially, a single UAV 602 was connected to ensure that real time battery information could be accessed by the system, i.e., laptop computer 606. This was necessary to prototype system 600 and without this capability, system 600 would not properly operate. The code reads the battery status of a single vehicle while connected and activates the next quadrotor when the battery's health, e.g., battery charge level, falls below a desired threshold.

Next, it was verified that all of the UAVs 602 connected to the network and provided real time system health information to the Python script. The code ensured that the UAVs 602 could report all information back to the ground control station—the laptop computer 606—without losing information from another vehicle.

In addition, the UAVs 602 needed to launch on command. The 3DR Solo drone code provided in DroneKit-Python experienced issues that caused the 3DR Solo drones 602 not to launch properly. Often, a UAV 602 would hover less than a meter above the ground, but the code would ignore the state of the UAV 602. A number of implemented checks warranted that the UAV 602 launched successfully before proceeding. Additional measures guaranteed that if a UAV 602 remained in the launch state, it could not continue until the UAV 602 reached the desired launch altitude or a replacement UAV 602 launched to that altitude in its place. This prevented the code from progressing before the UAV 602 was ready to respond.

For the test, the intended flight path was to transit to a specified latitude and longitude to loiter using the flight controller and Global Positioning System (GPS) onboard. Automated UAV 602 swapping was programmed into the prototype system, which raised the original aerial UAV 602 to a higher altitude before sending a replacement UAV 602. The replacement UAV 602 moved to occupy the position once held by the original UAV 602. Once the replacement UAV 602 moved into the loiter position, the original UAV 602 returned to the launch platform.

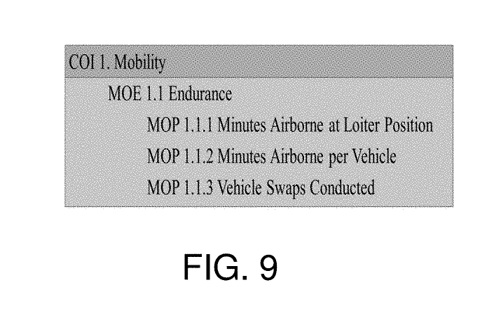

The primary critical operation issue (COI) addressed in the prototype system test and evaluation was its mobility. In order to achieve mobility capabilities, the measure of effectiveness (MOE) tested was mission endurance. Each measure of performance (MOP) evaluated is shown in FIG. 9. The loiter time (MOPs 1.1.1 and 1.1.2) is defined as the period that the vehicle occupies the desired position intended for the platform.

To evaluate the feasibility of the system, the loiter scenario was developed as follows. Each individual UAV 602 flies approximately 100 meters away from a launch point to an altitude of 100 meters and provides an aerial platform, an ASP, that loiters in this position until cancelled by the user or available batteries are exhausted. This simulates a real world environment where this system operates above a ship in port or ground base providing a nearby airborne platform for sensors. Each of the UAVs 602 include its gimbals and cameras to test with a payload. In one embodiment, the departing UAV 602 raises by about 5 m above the loiter point to give a way to a replacement UAV 602. In one embodiment, success for the system is defined as multiple aerial vehicle swaps when a user-defined battery charge threshold level of 30% is met, i.e., when the battery charge level of the operating UAV 602 is at 30%.

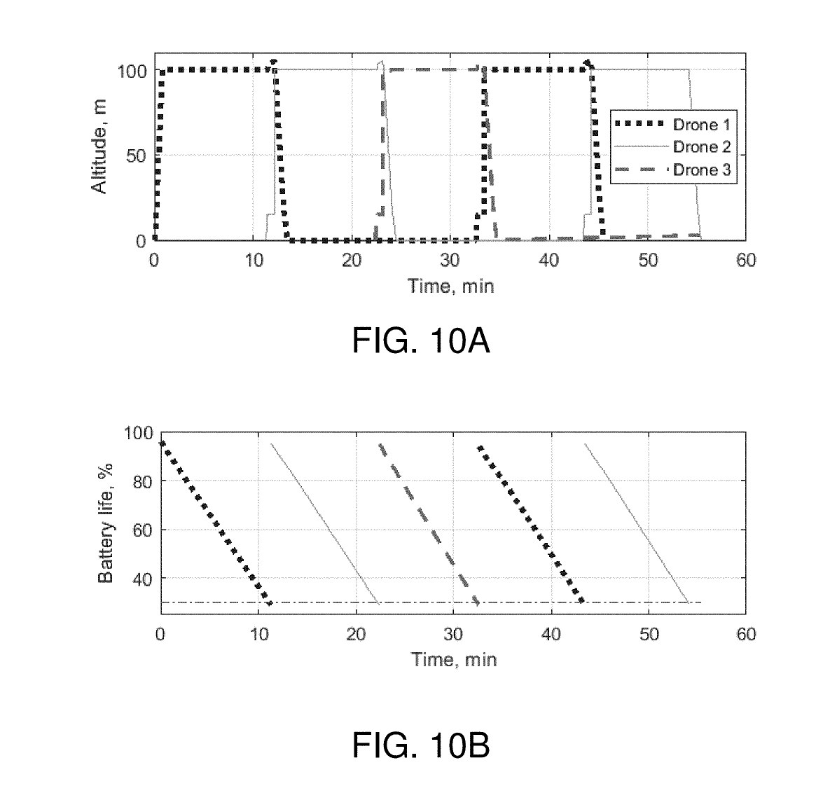

FIGS. 10A and 10B illustrate a summary of prototype system 600 field testing results utilizing three 3DR Solo drones, also referred to herein with respect to the prototype systems as UAVs, aerial vehicles and vehicles, and five batteries, while aviating for additional batteries to arrive. The results illustrated in FIGS. 10A and 10B illustrate that prototype system 600 successfully operated multiple aerial vehicles in the intended loitering position and swapped aerial vehicles autonomously. Vehicles 1 and 2 executed two sorties each, while Vehicle 3 executed just one as shown in FIG. 10A. The testing concluded after five available fully-charged 3DR Solo drone batteries fell below the 30% battery charge threshold level as shown in FIG. 10B. When an aerial vehicle returned to the launch platform with an expended battery, the aerial vehicle was turned off, equipped with a fully charged battery in place of the old battery, and the aerial vehicle was restarted. The aerial vehicle then reconnected with the network and the Python script would reconnect to the vehicle as the script progressed. As can be understood by one of skill in the relevant art, the aerial vehicle remained on the ground at the launch platform awaiting a call to replace an in use battery-depleting aerial vehicle.

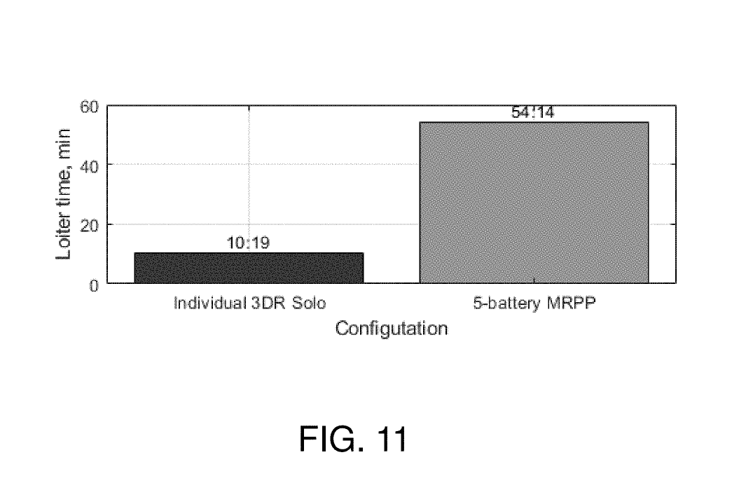

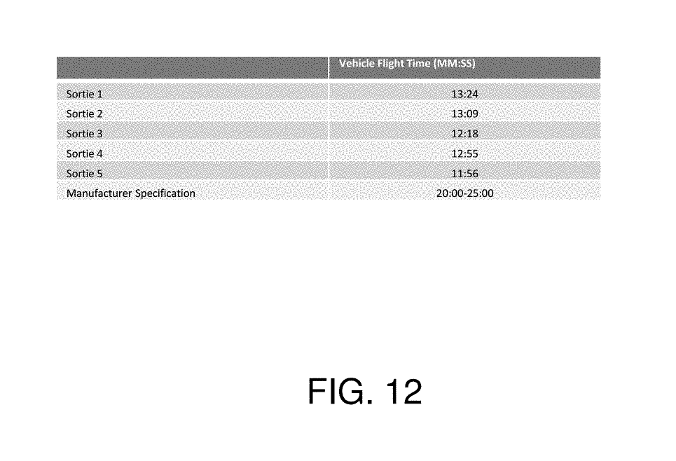

With the four aerial vehicle swaps, aerial vehicle coverage remained at the loiter position continuously for approximately 54 minutes, 14 seconds. When compared to the average individual vehicle loiter time of 10 minutes and 19 seconds, prototype system 600 provided more than five times longer coverage in the loiter area as illustrated in FIG. 11. FIG. 12 illustrates the overall flight time for each aerial vehicle, indicating that in practice, the 3DR Solo drones expended battery approximately twice as fast as the manufacturer's specifications. Instead of 20-25 minutes, as seen in FIG. 7, the aerial vehicles could only safely operate (hover) for 12-14 minutes.

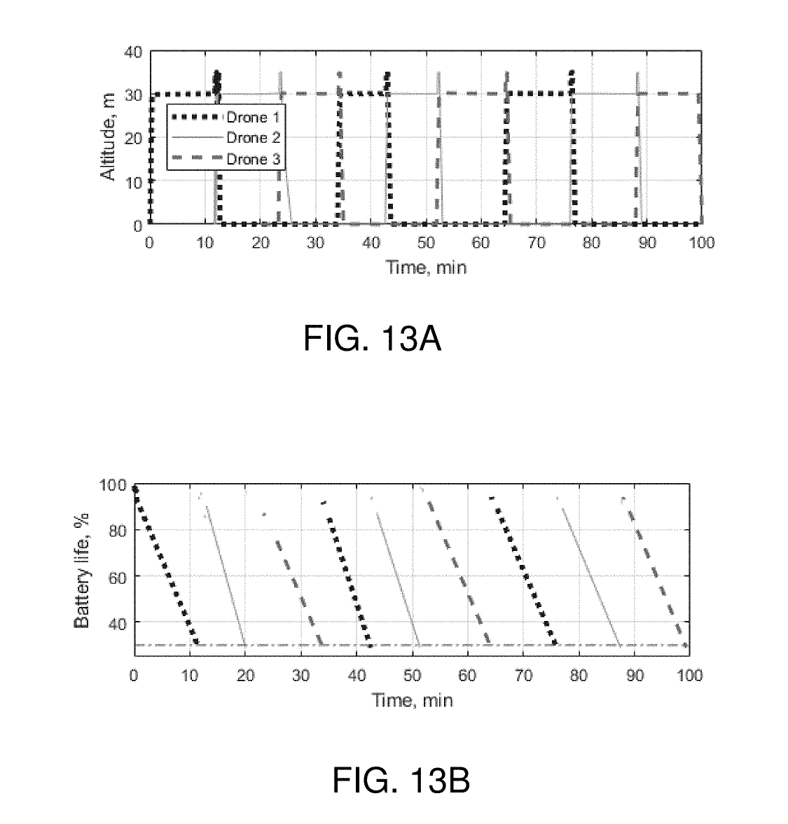

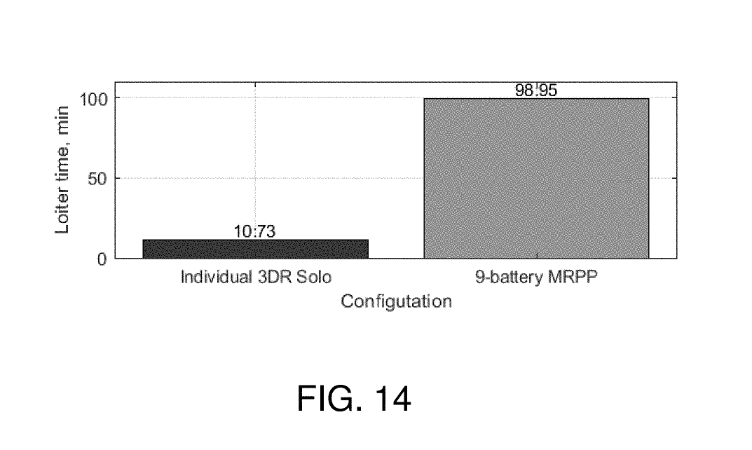

Additional tests were also conducted. FIGS. 13A, 13B and FIG. 14 illustrate the results of a full-scale three UAV, nine battery prototype system test. This test was conducted closer to the launch location and at 30 m loiter elevation, versus 100 m as in the previously described prototype system test. The results are similar to those of FIGS. 10A, 10B, and FIG. 11.

As described herein, embodiments in accordance with the invention manage multiple UAVs based on battery charge levels to provide a persistent airborne platform for ISR systems supported by the UAVs within an ASP. Embodiments in accordance with the invention described herein exceeded the capability of a single UAV while also providing a user with a survivable asset for persistent surveillance from an ASP.

This disclosure provides exemplary embodiments of the present invention. The scope of the present invention is not limited by these exemplary embodiments. Numerous variations, whether explicitly provided for by the specification or implied by the specification or not, may be implemented by one of skill in the art in view of this disclosure. For example, various means of recharging a UAV battery can be used, as well as various means for battery replacement. Further, although the embodiments described herein refer to a UAV leaving from and returning to BRL, in other embodiments, a UAV may leave from and return to a launch platform, and the battery charging or replacement may occur at a different location, and then the recharged UAV is moved to the launch platform. Additionally, although various types of UAVs and software programming language are described herein, other UAVs and programming languages can be used.

What is claimed is:

1. A system for persistent airborne surveillance comprising:
a plurality of unmanned aerial vehicles (UAVs), each of the UAVs comprising:
a battery for powering the UAV;
a battery charge level monitor;
a flight control module;
one or more intelligence, surveillance, and reconnaissance (ISR) systems, the one or more ISR systems for providing an associated airborne surveillance from an airborne surveillance pattern (ASP); and,
a communication module for sending and receiving communications;
a battery recharge/replacement station with a limited stock of fully-charged batteries; and, a computer-based control station for sending information to and receiving information from at least each of the UAVs, the control station comprising at least:
a method for persistent airborne surveillance, the method managing the exchange of a first UAV in the ASP with a next UAV based on the battery charge level of the first UAV, such that at least one UAV in the plurality of UAVs is actively operating in the ASP to provide persistent airborne surveillance by the one or more ISR systems,
a processor for executing the operations of the method; and,
one or more interfaces for communicating information from the control station to the plurality of UAVs.

2. The system of claim 1, further comprising a router, the router for communicating information between the computer-based control station and the plurality of UAVs.

3. The system of claim 1, wherein the plurality of UAVs comprises three UAVs.

4. The system of claim 1, wherein the plurality of UAVs comprises four UAVs.

5. A method for persistent airborne surveillance comprising:
a) sending a first unmanned aerial vehicle (UAV) to an airborne surveillance pattern (ASP), the first UAV having one or more intelligence, surveillance, and reconnaissance (ISR) systems for providing an associated airborne surveillance from the ASP;
b) receiving a battery charge level of the first UAV;
c) determining whether the battery charge level of the first UAV is greater than a specified battery charge level threshold;
d) wherein when the battery charge level of the first UAV is greater than the battery charge level threshold, awaiting receipt of a next battery charge level of the first UAV;
e) wherein when the battery charge level of the first UAV is not greater than the battery charge level threshold, sending a second UAV to enter the ASP, the second UAV having one or more ISR systems for providing an associated airborne surveillance from the ASP, replacing the first UAV with the second UAV in the ASP such that airborne surveillance by the one or more ISR systems is not interrupted, and sending the first UAV to a battery recharge/replacement location for battery recharge or replacement;
f) receiving a battery charge level for the second UAV;
g) determining whether the battery charge level of the second UAV is greater than the specified battery charge level threshold;
h) wherein when the battery charge level of the second UAV is greater than the battery charge level threshold, awaiting receipt of a next battery charge level of the second UAV;
i) wherein when the battery charge level of the second UAV is not greater than the battery charge level threshold, sending a third UAV to enter the ASP, the third UAV having one or more ISR systems for providing an associated airborne surveillance from an airborne surveillance pattern, replacing the second UAV with the third UAV in the ASP such that airborne surveillance by the one or more ISR systems is not interrupted, and sending the second UAV to the battery recharge/replacement location for battery recharge or replacement;
j) receiving a battery charge level for the third UAV;
k) determining whether the battery charge level of the third UAV is greater than the specified battery charge level threshold;
l) wherein when the battery charge level of the third UAV is greater than the battery charge level threshold, awaiting receipt of a next battery charge level of the third UAV; and,
m) wherein when the battery charge level of the third UAV is not greater than the battery charge level threshold, sending the first UAV to enter the ASP, such that airborne surveillance by the one or more ISR systems is not interrupted, and sending the third UAV to the battery recharge replacement location for battery recharge or replacement, and returning to operation b).

6. The method of claim 5 wherein the battery charge level threshold is greater than a battery charge level required to power a UAV from the ASP to the battery recharge/replacement location.

7. A method for persistent airborne surveillance comprising:
a) sending an unmanned aerial vehicle (UAV) to an airborne surveillance pattern (ASP), the UAV having one or more intelligence, surveillance, and reconnaissance (ISR) systems for providing an associated airborne surveillance from the ASP, the UAV becoming defined as an operating UAV while in the ASP;
b) receiving a battery charge level of the operating UAV;
c) determining whether the battery charge level is greater than a specified battery charge level threshold;
d) wherein when the battery charge level is greater than the battery charge level threshold, returning to operation b); and,
e) wherein when the battery charge level of the UAV is not greater than the battery charge level threshold, sending a next UAV to enter the ASP, the next UAV having one or more ISR systems for providing an associated airborne surveillance from the ASP, replacing the operating UAV with the next UAV in the ASP such that airborne surveillance by the one or more ISR systems is not interrupted, sending the operating UAV out of the ASP to a battery recharge/replacement location for battery recharge or replacement such that the operating UAV is no longer defined as an operating UAV, and the next UAV becomes defined as the operating UAV in the ASP; and returning to operation b).
